(19) United States
(12) Patent Application Publication
(10) Pub. No.: US 2002/0049967 A1
(43) Pub. Date: Apr. 25, 2002

(54) Processes for exploiting electronic tokens to increase broadcasting revenue

(76) Inventors: Eric C. Haseltine, Burbank, CA (US); Paul H. Dietz, Hopkinton, MA (US); Shelley O. Short, Pasadena, CA (US); Amy Van Gilder, Los Angeles, CA (US)

Correspondence Address: OPPENHEIMER WOLFF & DONNELLY LLP, 38th Floor, 2029 Century Park East, Los Angeles, CA, 90067-3024, US

(21) Appl. No.: 09/898,164

(22) Filed: Jul. 2, 2001

Related U.S. Application Data
(60) Provisional application No. 60/215,860, filed on Jul. 1, 2000.

(51) Int. Cl. H04N 7/16; G06F 17/60

(52) U.S. Cl. 725/23; 705/14

(57) ABSTRACT

A system and method for utilizing electronic tokens to increase broadcasting tokens is disclosed. Electronic tokens comprise encoded data that are embedded within broadcasting content and radiated from broadcast appliances, such as in the inaudible ranges of an acoustic spectrum or in an electromagnetic spectrum. The radiated tokens are then captured by a token capture device (TCD) possessed by a consumer. Upon receipt of the token from the broadcast, the TCD processes the token and becomes of value to the consumer. For example, the token may cause the TCD to light up, indicating that the consumer has won a prize. A TCD having indication of token receipt thereon may then be redeemed by the consumer for a prize, thus generating incentive for viewing the broadcast and using the TCD to capture the tokens embedded therein.

### RELATED APPLICATIONS

This Application claims the benefit of U.S. Provisional Application No. 60/215,860 filed Jul. 1, 2000, incorporated herein by reference.

### BACKGROUND OF THE INVENTION

1. Field of the Invention

This invention relates to broadcasting and methods for advertising therewith. More particularly, the invention relates to methods for distributing electronic tokens in a broadcast for the enhancement and improvement of advertising methods.

2. General Background and State of the Art

Television has long been enjoyed in our society as a means for delivering information for the enhancement of knowledge as well as for providing content with entertainment value. As such, television has also served as a valuable medium through which to direct advertisements to viewers. In all of its uses, however, television has remained a one-way experience for the viewer. In fact, television has in many cases been criticized for simply “feeding” broadcast material to viewers without requiring any thought, participation, or feedback from the viewers. Paralleling the one-way experience of television's entertainment and informational content, its advertising content is unidirectional, and does not require participation of the viewer. This lack of viewer participation with advertisement commercials substantially hinders their effectiveness.

Advertising effectiveness has long been addressed by prior art marketing technologies and approaches. For example, audience groups are regularly evaluated, characterized, and accordingly targeted by certain types of advertising content. However, even these approaches to specific audience targeting for the purpose of capturing viewers' attention do not provide adequate incentive for a viewer to substantially acknowledge and absorb the advertising content.

### SUMMARY OF THE INVENTION

Accordingly, it is an object of the invention to provide television advertising content, and methods related thereto, for capturing an audience's attention through providing incentives to participate with the advertising content as a means for achieving a previously unknown high level of audience acknowledgement and retention of advertising content in television broadcasts.

Another object of this invention is to use electronic tokens to generate new revenue from broadcasting by incentivizing sponsors and advertisers to fund promotions and token capture devices.

A further object of this invention is to minimize the cost of token receivers and rewarding consumers for assuming some or all of their cost.

Another object of the invention is to generate multiple advertising impressions from providing branded messages on a token capture device.

Another object of the invention is making the experience of capturing electronic tokens fun enough and rewarding enough to increase audience reach and to stimulate collection of token capture devices.

Another object of the invention is creating cross-promotions that create incentives for consumers to purchase multiple brands or product offerings.

A further object of the invention is employing consumer usage data gained from a consumer's redemption of the tokens for audience measuring and targeted data base marketing.

An additional object of the invention is using token receivers previously imbedded in toys or other devices for the purpose of synchronizing toy behavior with a broadcast show, as electronic coupons, frequent viewer product promotions or cross promotion campaigns.

These and other objectives are achieved by the present invention, which, in a broad aspect, provides a high degree of incentive for television viewers to participate in television commercials for the purpose of maximizing advertising effectiveness.

A method according to one embodiment of the invention will utilize a token capture device (TCD) to be used with TV or radio programming, or programming or other transmission of information in any medium, such as the Internet, which is adapted to transmit tokens. Tokens are akin to coupons, and represent a right, authority or identity. Applications for the device may include, but are not be limited to, electronic coupons, play-along games, contests, frequent viewer/loyalty programs, and various combinations thereof.

The TCD will be programmed to receive tokens, for example, audio tokens, from a viewer's TV or a listener's radio set, which is emitting a programming broadcast signal, and to display the results of these token captures to the viewer or listener and to an associated product redemption staff. The TCD supports a number of different functional applications. These may be play-along games in which viewers enter predictions or other selections relevant to a live broadcast, then receive tokens denoting the correct selection that can be used by the TCD processor to score the user. Electronic coupons delivered as an unnoticeable addition to the audio contents during commercials are another possible function, wherein the coupons can be grouped into different classes. Each class can be incremented independently, or the total number of the coupons related to all classes can be incremented, depending on the required scenario. Electronic lotteries, instant lotteries, different collection games, promotion games, booth attending promotions and the like may also be related functional applications. There may be contests in which a subset of the TCDs are programmed to behave in a unique manner upon receipt of a token. For example, certain tokens can double the number of prior accumulated tokens. Frequent viewer programs in which viewers may receive discounts or free merchandise based upon the number of tokens they have received are anticipated. Also, hybrid applications in which the TCDs perform any of a combination of the functions described above are possible.

In all of these functions, among others, the TCD will be supported without requiring changes to its core processor or other digital components, except for reprogramming of EEPROM, masked ROM, or other non-volatile memory means included within the TCD. This optional re-programmability allows that in addition to displaying alphanumeric characters, the combination of the system processor and LCD display permits the readout of arbitrary non-alphanumeric patterns that turn on and off each pixel of the LCD to create simple graphics. Similarly, non-processing/memory components, including the LCD, buttons, battery and sensor are capable of being configured in different geometries within the boundaries of the TCD format, without requiring component redesign or use of alternate components.

Tokens make their way to the TCDs through a chain that begins with the tokens being embedded into the video (or audio) signal of either a live or stored program. The token data may take the form of intensity variations in the audio or video signals of the broadcast. After embedding, the tokens are transmitted along with the primary video and/or audio signal, received by the user's broadcast receiving appliance (e.g. television, radio or computer), then radiated either in the electromagnetic or acoustic spectrum from the broadcast receiving appliance in such a manner that the TCD's sensor picks up the token signal and passes it to the logic unit/decoder for processing. Tokens can also be embedded in computer graphics for display of software and Internet applications on computer monitors, in radio broadcast audio signals, in motion picture films or in any modulated light, infrared or acoustic emitter.

### BRIEF DESCRIPTION OF THE DRAWINGS

FIG. 1 illustrates a front view of an exemplary TCD according to the present invention.

FIG. 2 illustrates a back view of the exemplary TCD according to the present invention.

FIG. 3 illustrates exemplary steps utilized in a system according to the present invention.

FIG. 4 illustrates exemplary steps utilized in a marketing system according to the present invention.

### DETAILED DESCRIPTION OF PREFERRED EMBODIMENTS OF THE INVENTION

In the following description of the present invention reference is made to the accompanying drawings which form a part thereof, and in which is shown, by way of illustration, exemplary embodiments illustrating the principles of the present invention and how it may be practiced. It is to be understood that other embodiments may be utilized to practice the present invention and structural and functional changes may be made thereto without departing from the scope of the present invention.

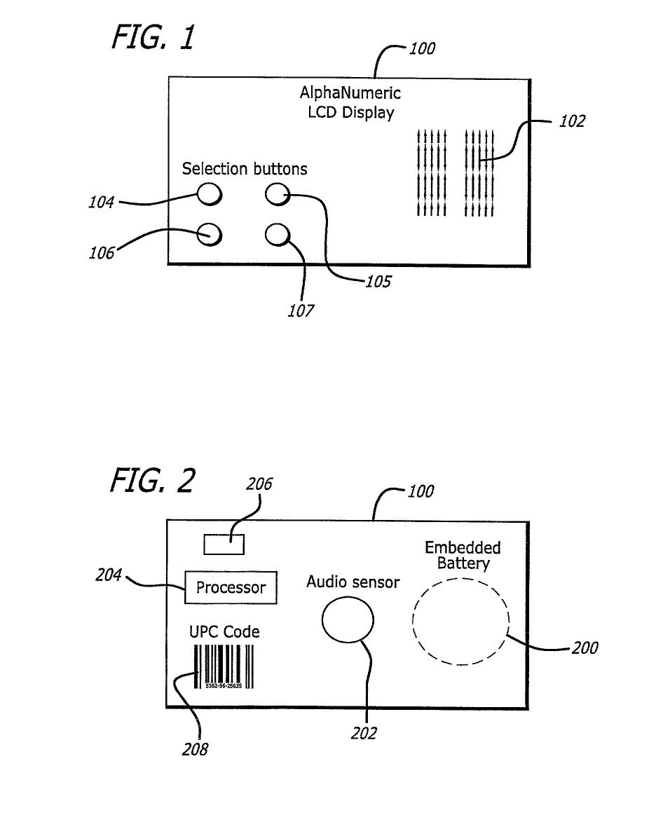

FIG. 1 illustrates a front view of an exemplary TCD 100 according to the present invention. The TCD may take the form of a credit-card sized smart card, key chain, calculator, personal digital assistant, cellular telephone, jewelry item or other accessory, toy, smart book, or other personal artifact incorporating a signal processor. The TCD includes a display 102, which is used for displaying various types of information to a consumer. For example, brand information previously stored within a TCD's memory may be displayed on display 102, which may be an LCD or LED, for example. Display 102 may also be used to display a status of received tokens. For example, display 102 may provide an indication that a token has been received by TCD 100. In this regard, display 102 may comprise a plurality of separate displays 102. Each display 102 may be associated with receipt of a separate token, such that a single display 102 is activated upon receipt of a single token. For example, during a season of television shows, a token may be broadcast during each episode. Each token would cause activation of a different display 102, such that at the end of the season, TCD 100 would indicate, through its displays 102, which of the episodes were watched by the consumer in possession of TCD 100. Alternatively, a plurality of displays 102 may be utilized with a single token. For example, a token may be broadcast with a restaurant television commercial. The token, when received and processed by TCD 100, would cause only one of displays 102 to become activated. Each display 102 would represent a different feature, such as a different prize that the TCD holder could win. The token, however, activates only one display 102, which may earn the TCD holder a prize or may instruct the TCD holder to “try again.”

Other possible display means include electroluminescent, electrophoretic or electronically activated pigments. Acoustic displays, such as speakers that emit tones, stored voice or music are also possible and may be utilized in TCD 100.

TCD 100 may include a variety of other features as well. For example, a single button 104, or a plurality of buttons 104 may be provided to give a TCD holder control over the utilization of TCD 100. In FIG. 1, the plurality of buttons are shown as 104, 105, 106 and 107, but any number of buttons may be provided, n any location on the TCD as is practicable. The buttons may be labeled on TCD 100. For example, button 104 may be labeled “A”, 105 “B”, 106 “C” and 107 “D”. Button 106 may be labeled “Capture” and button 107 may be labeled “Read Out”. TCD 100 may be programmed to perform a plurality of functions or to be utilized in a plurality of different games. Activation of a button, such as 104, 105, 106 or 107, or any combination of buttons by the TCD holder would result in selection of one of the functions or prepare TCD 100 to be utilized in one of the games.

FIG. 2 illustrates a back view of TCD 100. To provide power, a battery 200 may be embedded within TCD 100. Sensor 202 detects radiated tokens and may be, for example, an audio sensor such as a microphone or an optical sensor such as a photodiode. Therefore, tokens may be comprised of any type of signal or signals, including audio, optical, electromagnetic, etc. A processor 204 is also included, and receives the token from sensor 202. Processor 204 recognizes tokens and converts them to triggers or event flags, which may be stored in memory 206 and cause display 102 to be activated. Also, TCD 100 can include an indicator 208 for identifying TCDs or tracking consumers. Indicator 208 may be, for example, a UPC code, glyph or other printed indicia.

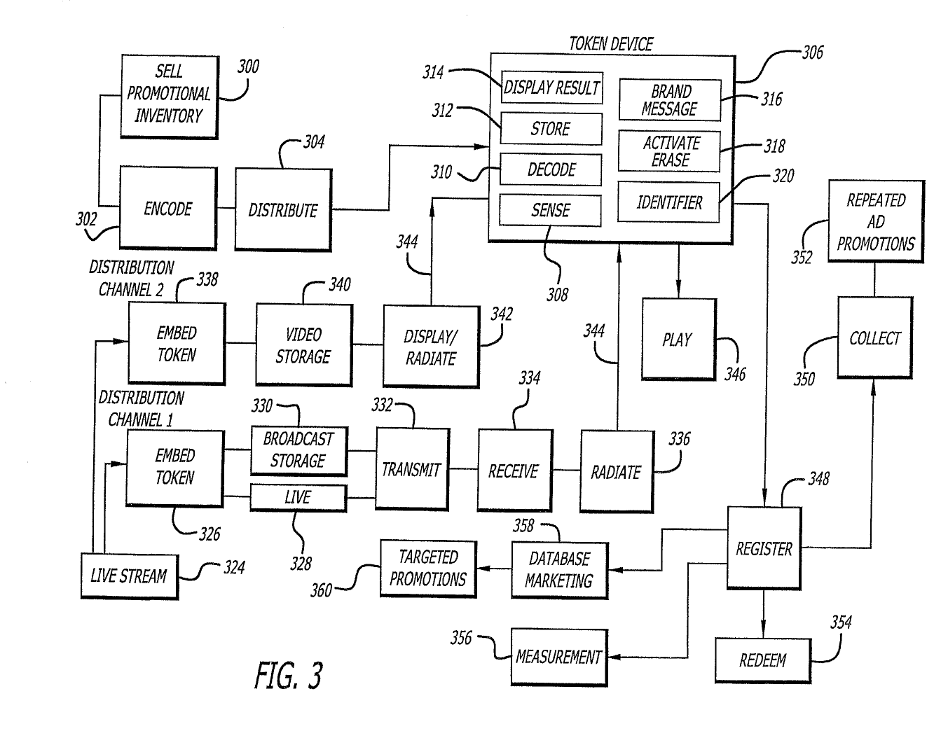

FIG. 3 illustrates a flow chart that sets forth exemplary steps taken in a system according to the present invention. In such a system, a TCD must first be designed and created. Therefore, the purpose of the token and the TCD is identified as an initial step. As indicated at block 300, the purpose used for the instant exemplary embodiment is to sell promotional inventory. The TCD device is then encoded, as indicated at block 302. Encoding comprises programming the logic unit within the TCD to process a received token. For example, a logic unit within the TCD may be programmed to recognize a particular type of token, receive the token, and convert the received token to a trigger or flag event. The TCD, once encoded for a particular type of token and function, is then distributed to consumers, as shown at block 304.

An exemplary TCD, as illustrated generally at 306, performs various functions as illustrated therein. For example, a typical TCD may have the ability, through a sensor, to detect and receive a token, as illustrated at block 308. Block 310 illustrates the ability of the TCD to decode a received token, such as with a logic or processing unit. The TCD has memory with which to store information related to receipt of tokens, as indicated at block 312. Block 314 identifies the ability of the TCD to display information about receipt of tokens, such as with an LED, LCD or audio display. Block 316 illustrates an optional feature of a TCD, which is to include a message, either visual or audio, related to the associated token type. For example, brand information may be included with the TCD for presentation to a consumer. Blocks 314 and/or 316, or additional display blocks, may display any desired information, for example, a description of the promotional inventory. Block 318 identifies a feature that the memory TCD may be optionally erased, such as to re-set a TCD and allow re-use. As indicated at block 320, the TCD may also include an identifier, such as a UPC code or other written mark, for identifying a particular TCD during a redemption procedure, tracking TCDs, and tracking consumer information about consumers using particular TCDs. The identifier may also comprise an electronic signal, and communication between the TCD and token transmitter may be bidirectional.

Along with creation and encoding of the TCDs, tokens are created for use therewith. As indicated at block 324, a live stream of information is identified for association of tokens therewith. The live stream may comprise prerecorded information. Tokens are delivered to broadcast appliances, such as televisions, radios, computers and the like, in conjunction with programming contained in the live stream. For example, as indicated at block 324, a live stream is identified, and a token is embedded therein, shown at block 326. The token may be embedded, for example, in the audio stream, video stream, or as an IR or other electromagnetic radiation component of the live stream. The broadcast and token are then broadcast to a consumer, either live, as indicated at block 328, or from broadcast storage, as indicated at block 330, or a combination of the two. The embedded token is also transmitted, as indicated at 332, and received by the consumer's broadcast receiving appliance (television, radio, computer, etc.), shown at block 334. The broadcast receiving appliance radiates the token, shown at 336. For example, if the token is encoded as an audio signal, a consumer's television would radiate the token as part of the acoustic spectrum, preferably outside of a normal hearing frequency range. Alternatively, a token can be radiated in the electromagnetic spectrum, or as an IR signal.

In an alternative arrangement, a token may be embedded in the live stream as shown at block 338, and stored, with the live stream, on video storage as indicated at block 340. An autonomous, hand-held micro-controller based preprogrammed device or a PC based hardware and software system may be used for embedding tokens in contribution quality audio at the network or point of broadcast. Embedded tokens according to the preferred embodiment are able to survive MPEG 2 compression, decompression and digital transmission down to 2M bit/sec, as well as analog transmission over the air and cable. Tokens, in the preferred embodiment, are also able to survive at least one generation of videotaping in the home.

The programming and token are displayed and radiated by a consumer's broadcast appliance as described above and as indicated at block 342. Radiated tokens are sensed by a TCD 306, as illustrated at block 308. The TCD 306 processes a received token as described above, which enables a consumer in possession of the TCD to play a game, for example, as indicated at block 346 by manipulating buttons 104, 105, 106 and 107, or by using the TCD 306 to unlock or activate a game player. Moreover, utilizing identifier 320, the consumer is able to register with the TCD provider, as indicated at block 348. A registration process may comprise a variety of different features and serve a variety of purposes. For example, the programming and tokens may be tailored to the TCD holder's buying or viewing preferences.

As indicated at block 350, TCDs that have received tokens may be collected by the TCD provider, which may or may not exchange collected TCDs for prizes or the like. The TCD memory may then be erased or re-set, and the TCD may be re-distributed for use in repeated promotions, as indicated at block 352. Also, as indicated at block 354, a TCD having an indication thereon, or a signal registered therein, of a received token may simply be redeemed for a prize, for example. During a collection or redemption process, the TCD provider would have the opportunity to collect information from the consumer presenting the TCD. Such information may be used for consumer participation and habit measurements, as indicated at block 356. Moreover, the information may be stored in a marketing database as indicated at block 358 and used for future targeted promotions, as indicated at block 360.

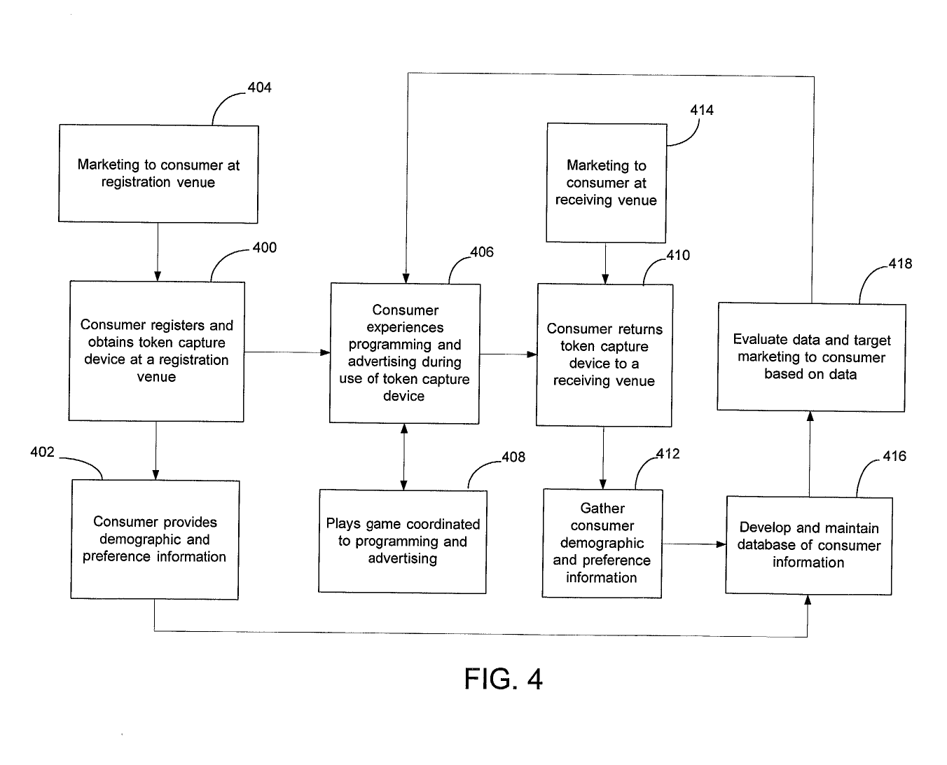

The registration and redemption process is generally depicted in FIG. 4. As depicted in block 400, the consumer enters a registration venue (physical or electronic) and registers to obtain a TCD. During that process, the consumer provides demographic and preference information (block 402). In conjunction with the registration process, the consumer experiences marketing (block 404), for example, in the form of point of sale merchandising. The consumer then uses the TCD to experience programming and advertising (block 406), as in a television broadcast. Use may take the form of playing a game coordinated to the programming and/or advertising (block 408). After token receiving devices 100 have accumulated enough of the right kind of tokens, consumers redeem them by delivering them to a point of sale or other registration point (block 410), where the identifier codes are recorded, and any information the consumers wish to divulge about themselves are noted (block 412). The information is stored in a database (block 416) for later demographic analysis and database marketing (i.e., targeted promotions to consumers with demonstrated buying patterns, demographics, characteristics or habits) (block 418). While the consumer is returning the TCD (block 410), the consumer experiences marketing (block 414), for example, as point of sale marketing. The targeted information is then included in programming, which the consumer will see in future sessions at block 406. The database is regularly updated and reanalyzed, and the content provided to the consumer at block 406 is accordingly modified.

Registration data can also be used to measure how many consumers watch or listen to a given broadcast program or commercial, or visit other venues that radiate tokens. With frequent viewer systems, additional measurements of viewing habits within individual programs can be gathered. Registration and redemption can take place in retail outlets, restaurants, service stations, movie theaters, theme parks, hotels, outdoor kiosks, or over the Internet or interactive TV return paths. In the case of Internet or interactive TV redemption, users can type or otherwise in the data displayed on the token device along with identifier information to determine what, if anything they have won.

The description will now continue with reference to an exemplary game that may be utilized with a TCD 100 in a system according to the present invention. An exemplary embodiment is a configuration of a TCD 100 that is programmed to implement a television game show play-along game as follows. The object of the game is to pick as many correct answers as possible during a broadcast, scoring one new point for each correct answer. Unlike the broadcast game, points will accumulate across multiple contestant rounds.

At the beginning of the broadcast, a token will be radiated indicating start-of-show, initializing the game. At the start of each new contestant's opportunity (i.e. just before guess number 1), the network will radiate an initializing token that will cause the TCD processor to reset the current game to zero dollars. Then, during each successive round for that contestant, viewers will press the A, B, C or D buttons (104, 105, 106 or 107) when they are ready to guess their “final answer.” Once a selection is made, the appropriate letter will be displayed on the left alphanumeric character display 102, and no new selections will register until a new token is received denoting the next guessing round or new contestant. Immediately after the game show host reveals the correct answer each round, an audio, optical, electromagnetic or other token will be radiated to the TCD 100 indicating which of the four choices was correct. The processor will then display the correct letter in the right LCD 102, compare the correct answer to that selected by the viewer, then increment the count shown on the alphanumeric readout by one if the correct answer matches the guess. If the guess and answer do not match, the counter will not increment. At the beginning of each guessing round, the letter readouts will be cleared from the LCD 102, revealing the point total. Assuming 15 questions in a game, if the viewer and contestant both pick all 15 answers correctly, the alphanumeric counter would display a flashing 15 at 1 HZ for approximately 10 seconds. At the end of the broadcast, the network will radiate an end-of-broadcast token that causes the processor to add up and display all of the points collected during that broadcast. When the TCD 100 receives the start-of-broadcast token for the next show, it will reset the game counter to zero and re-initialize the game for a new show.

In the exemplary embodiment, in the absence of a reset token, the TCD 100 will store the point total for at approximately 30 days. The point total can be read out for approximately 5 seconds at any time by pressing the A and B (104 and 105) buttons simultaneously. The design of the TCD shall also support the device's use as an electronic coupon/frequent viewer system as follows. The card allows viewers to activate the sensor 202 in proximity of the TV, radio or other transmitting device, after a message appears on the screen, or audio announcement indicating the presence of a token available. The customer then presses Capture & Readout buttons (106 and 107) to acquire the token.

Normally, TCD 100 of the preferred embodiment will be a card and will be in “sleep mode” (to maximally conserve battery life), which can be exited by briefly pressing any of the buttons. When awakened, the card will actively search for tokens for a period of at approximately 30 minutes. If no tokens are found in this time, the card returns to sleep mode. Otherwise, the tokens found will reset the time remaining until returning to sleep mode. In the case of a program longer than 30 minutes, the tokens can automatically extend the powered-on time, and even power down at the end of the show.

Upon token acquisition, the token count will be incremented and shown on a LCD alphanumeric display 102 for approximately 15 seconds. After such time, the LCD display will extinguish to preserve battery life. At any time, viewers can press the readout button for a specified time, such as 3 seconds, to turn the card on to display the token count.

The card, TCD 100, will require a new token each time to increment the token count. Depending on the application, the TCD will need to recognize different numbers of unique tokens. This number could be anywhere from one to many, and each token may have varying data bit lengths, from perhaps 5 to 13, or any other number of bits compatible with the hardware and software. If the amount of data to be transmitted, recognized and displayed is relatively high, the present invention can include support for sending and receiving data via token data streams.

The token count may be reset to zero via the card 100 interface 202 and the token transmitting device (e.g. television) or via a telephone, or both. This will allow the card to be “erased” following fulfillment, then re-used if desired. Another method of resetting the TCD 100 to zero would be via a manual sequence of short (for example, less than 1 second) and long (for example, greater than 2 seconds) button pressings. This will allow the card to be “erased” following fulfillment, then re-used if desired. The card 100 can be permanently “erased” by the card interface 202 (block 308) for those applications where it is desired to limit the number of uses.

In the preferred embodiment, the TCD 100 is able to capture tokens at a distance of up to approximately 20 feet from the TV or radio with normal household ambient background noise. TCDs according to the preferred embodiment are also able to capture tokens under conditions of large sudden noises. Token capture probability, taking into account variations in audio TV or radio settings should generally be greater than 95% in preferred embodiments of the invention. Of course, these thresholds may be varied depending upon operational preferences.

One aspect of the present invention is to provide an incentive to consumers to both watch commercials and the programming into which the commercials are placed. The system modulates the video, audio or other signal in an invisible way so that the token capture device reads and stores a token or coupon used in the incentivization process. The incentive becomes much more meaningful when the consumer receives instant gratification for using it, as when playing a game device. The game is based upon what appears in, or what is the subject matter of, the commercial and/or the programming into which the commercial is placed. Examples of such programming based games are a “predict-the-play” game during a sports event, or predicting the winner on an awards show such as the Academy Awards. Another example would be predicting the winner, or choosing the right answers on a quiz show such as Who Wants To Be A Millionaire? Multiple viewers could use multiple TCDs, allowing them to compete with each other in the same viewing room.

There may be many other types of games, electronic coupons or other applications employing the system of the present invention. Several examples are:

Watching LED's on the TCD cycle through possible prizes, ultimately landing on a particular prize (or “try again”)

Accumulating points, displayed either as incrementing LED's or incrementing counts on a numeric display

Accumulating special events, such as when actors kiss, with the payoff being activation of a tone generator that dials an 800 number for a personalized message

A contest in which users collect tokens that may be redeemed for a sweepstakes prize

A game associated with a race or sporting event in which viewers pick their horse, driver, team or player, as appropriate, then receive tokens at the end of the contest that represent the winning contestant. If the actual winner matches the selected winner, the viewer would be eligible for a prize, either on direct redemption, or from a drawing

Play-along games with game shows in which viewers make their selections on the token device and receive tokens indicating which of their choices were correct

Scavenger hunts in which users collect multiple tokens from different programs, media venues, retail outlets or other businesses, and are rewarded for completing a collection of tokens

Token receiver devices that interface with one another to create a composite artifact that has collector value. An example would be smart cards, bearing partial images that link together, as in tiles in a mosaic, to form a completed picture.

A synthetic pet or companion that must be “fed” tokens to remain “alive”, “healthy” or “happy”

It is well known that in order to elicit a behavior in a person, instant gratification works as a powerful reinforcer to the conditioning stimulus, especially when the reinforcement occurs as soon as possible after the occurrence of the conditioning stimulus. In other words, if the behavior we desire is a consumer watching a commercial and/or television programming, the behavior may be increased if the consumer receives an instant reward, which may be playing a game during the commercial and/or programming itself. According to the present invention, the TCD is employed in this process of providing gratification.

Additionally, as discussed previously, an option available with the present system is registering and tracking users of TCDs. In this way, demographics, purchasing preferences, viewing history of programming and commercials, and other marketing information may be gathered. How and where the TCD was obtained may be recorded, as well as where the device was redeemed. All of the foregoing, and other information may be stored in a database. It will be appreciated by those skilled in the art that that when this information is known, marketing promotions may be more effectively targeted to the consumers.

Also, the process contemplates distributing TCDs at locations where consumers are sought, such as large electronics stores, amusement parks or other venues that seek consumers. For example, a consumer would visit a store to obtain a TCD, and while there, the store would have an opportunity to market merchandise or services to the consumer. The same would occur when the consumer went to a venue to redeem the TCD. In marketing parlance, the system of the invention would drive traffic into a location. Therefore, the invention not only incentivizes consumers to watch and/or hear programming and advertising, it incentivizes them to visit stores or other locations that depend on visitors or consumers. This also applies to Internet based stores, or other online stores, which issue and/or redeem TCDs. The consumer is given an incentive to visit, and while there, the merchant, sponsor or other operator has the opportunity to interact with the consumer. The system of the present invention may generate consumer traffic to the point of distribution or sale of the TCD, it may generate traffic to the media (television, radio, movie, Internet or other), traffic back to the store to redeem or renew the TCD and the tokens, points or coupons represented therein, and it may gather data on those individuals. The combination of some or all of these features presents a powerful advertising package because it incentivizes consumers to actually interact with a merchant or other provider of goods and/or services, increasing the probability of consummating a sale or other delivery of good and/or services.

Redemption of tokens captured by a TCD according to systems of the present invention may take a plurality of different forms. In a first example, TCD holders may redeem tokens automatically at a point of sale/retail outlets where TCD holders return the TCDs, display their tokens, and receive their product or service. In this mode, indicator 208, which may be a UPC code, may be scanned and registered. Alternatively, TCD holders may mail their TCDs to redemption centers for fulfillment. Still another method contemplated within the scope of the present invention utilizes the Internet. With this redemption method, TCD holders visit a web site, register, enter the values displayed on the LCD along with the human readable indicator 208, which may be a number below the UPC code (or other unique identifiers printed on the TCD or broadcast during the program and readable on the display 102) and receive products and services through the mail or other delivery methods. Tones, or other signals from the sensor 202 can also be used with a personal computer microphone or other signal receiver such as an IR port to verify reception of tokens to prevent fraud. This method would include a challenge and response type system to allow some appreciable degree of security. Still other forms of redemption methods are possible. For example, TCD holders may redeem their TCDs by telephone, over a standard phone line, using the touch tone phone and/or computer telephony equipment as presently exists or may later be developed. An optional Piezoelectric Transducer, PZT, on the TCD 100 would be used as the transmitter and receiver to provide the bidirectional audio communication between the TCD and the phone. Again, this method includes a challenge and response system for additional security. Still another means for redemption involves automatic redemption by a TCD holder through a vending machine, video game machine or the like, using an optional electrical interface that may be included on the TCD. This interface may take any number of forms well known in the art, including plug in connectors, IR ports or electromagnetic field coupling.

The foregoing descriptions of exemplary embodiments of the present invention have been presented for purposes of enablement, illustration, and description. They are not intended to be exhaustive of or to limit the present invention to the precise forms discussed. Many modifications and variations of the present invention are possible in light of the above teachings. For example, tokens are not limited to being radiated as part of an audio or video signal. Rather, they may be transmitted as an IR signal, such as through a set top box. Also, the present invention is not limited to use with television. Rather, the invention may be utilized in any visual or audio display, such as in a motion picture screening or on a video game machine. It can also be used at a physical site, such as within an attraction or venue to track and incentivize the movements of the TCD holder.

What is claimed is:

1. A method for providing incentive to a user to receive information, the method comprising:
providing a programming broadcast signal;
providing a token with the programming broadcast signal;
providing a token capture device configured to receive the token during the providing of the programming broadcast signal; and
providing an incentive for using the token capture device to receive the token.

2. The method according to claim 1, wherein the token capture device is further configured to process the token.

3. The method according to claim 1, wherein the token is contained within the programming broadcast signal.

4. The method according to claim 1, wherein the programming broadcast signal embodies a television broadcast.

5. The method according to claim 1, wherein the token is a light token.

6. The method according to claim 1, wherein the token is an audio token.

7. The method according to claim 1, wherein the token is an infrared token.

8. The method according to claim 1, wherein the programming broadcast signal embodies a radio broadcast.

9. The method according to claim 8, wherein the token is an audio token.

10. The method according to claim 1, wherein the incentive comprises providing a reward in exchange for redemption of a token capture device having indication thereon of a received token signal.

11. The method of claim 1, wherein the information is advertising.

12. The method according to claim 10, further comprising collecting personal information from a person during the redemption of the token capture device.

13. The method according to claim 12, further comprising:
storing the collected personal information; and
using the stored collected personal information in a demographic analysis.

14. A token for including with an programming broadcast signal, the token comprising:
a token signal containing encoded data, the token signal configured to be received by a broadcast receiving appliance also receiving a broadcast signal, the signal further configured to be radiated by the broadcast receiving appliance and captured by a token capture device.

15. The token according to claim 14, wherein the broadcast receiving appliance is a television.

16. The token according to claim 16, wherein the broadcast receiving appliance is a radio.

17. The token according to claim 14, wherein the broadcast receiving appliance is a set top box.

18. The token according to claim 14, wherein the configuration of the token signal is spread spectrum pseudo noise and the token signal is radiated by the broadcast appliance in an acoustic spectrum.

19. The token according to claim 18, wherein the token capture device captures the radiated token signal below a hearing threshold.

20. The token according to claim 14, wherein the configuration of the token signal is an intensity variation of a video signal of the broadcast signal and the token signal is radiated by the broadcast appliance in an electromagnetic spectrum.

21. The token according to claim 14, wherein the broadcast receiving appliance is a personal computer.

22. The token according to claim 14, wherein the broadcast receiving appliance is a signal processor.

23. A token capture device for capturing a token signal during presentation of an advertisement, the token capture device comprising:
a housing;
a sensor attached with the housing and configured to receive a token signal;
a logic unit, operatively connected to the sensor, for decoding and processing the token signal; and
a storage medium for recording data related to receipt of a token signal; and
a display for indicating the receipt of a token signal.

24. The token capture device according to claim 23, wherein the sensor is an audio sensor.

25. The token capture device according to claim 24, wherein the audio sensor is a microphone.

26. The token capture device according to claim 23, wherein the sensor is an optical sensor.

27. The token capture device according to claim 26, wherein the optical sensor is a photodiode.

28. The token capture device according to claim 23, wherein the logic unit converts a received token signal into a trigger.

29. The token capture device according to claim 23, wherein the display is an LED.

30. The token capture device according to claim 23, wherein the display is an LCD.

31. The token capture device according to claim 28 wherein the display is activated by the trigger.

32. The token capture device according to claim 23 wherein the logic unit is programmed to display information based upon receipt of a single token.

33. The token capture device according to claim 23 wherein the logic unit is programmed to display information based upon receipt of multiple tokens.

34. The token capture device according to claim 23, wherein the display is an acoustic display configured to emit a tone.

35. The token capture device according to claim 23, further comprising a battery.

36. The token capture device according to claim 23, further comprising an identifier.

37. The token capture device according to claim 36 wherein the identifier is a UPC code.

38. A system for providing incentive to receive advertising, the system comprising:
a broadcast signal;
a token signal associated with the broadcast signal;
a token capture device configured to receive the token signal; and
a means for providing incentive to cause the token capture device to receive the token signal.

39. The system according to claim 38 wherein the incentive comprises allowing redemption of a token capture device having indication thereon of a received token.

40. The system according to claim 39 wherein the redemption comprises exchange of the token capture device having indication thereon of the received token for a prize.

41. The system according to claim 38 wherein the broadcast signal comprises an advertisement.

42. The system according to claim 38 wherein the broadcast signal embodies a television program.

43. The system according to claim 38 wherein the broadcast signal embodies a motion picture film.

44. The system according to claim 38 wherein the broadcast signal embodies a radio program.

45. The system according to claim 38 wherein the broadcast signal embodies a computer software program.

46. A method for providing incentive to receive advertising, the method comprising:
providing a programming broadcast signal;
providing an audio token with the programming broadcast signal;
providing an audio token capture device configured to receive the token during the providing of the programming broadcast signal; and
providing an incentive for causing the token capture device to receive the token.

47. A token for including with an programming broadcast signal, the token comprising:
a token signal containing encoded audio data configured as spread spectrum pseudo noise, the token signal configured to be received by a broadcast receiving appliance also receiving a broadcast signal, the signal further configured to be radiated by the broadcast receiving appliance in an acoustic spectrum and captured by a token capture device.

48. The token according to claim 47, wherein the token capture device captures the radiated token signal below a hearing threshold.

49. A token capture device for capturing a token signal during presentation of an advertisement, the token capture device comprising:
a housing;
an audio sensor attached with the housing and configured to receive a token signal;
a logic unit, operatively connected to the sensor, for decoding and processing the token signal; and
a storage medium for recording data related to receipt of a token signal; and
a display for indicating the receipt of a token signal.

50. The token capture device according to claim 49, wherein the audio sensor is a microphone.

51. A method for marketing to consumers, the method comprising:
providing a registration venue;
gathering consumer information from the consumer at the registration venue;
delivering advertising to the consumer at the registration venue;
entering the consumer information into a database;
furnishing to the consumer a token capture device;
providing programming to the consumer;
the consumer using the token capture device during the course of the programming;
providing tokens during the course of the programming;
the token capture device receiving the tokens;
the consumer returning the token capture device to a receiving venue;
gathering token information from the token capture device;
delivering advertising to the consumer at the receiving venue;
entering the token information into a database;
preparing promotional material based, at least in part, on the information in the database;
providing additional programming to the consumer;
providing the promotional material to the consumer in conjunction with providing the additional programming.
